(19) United States
(12) Patent Application Publication
(10) Pub. No.: US 2026/0066737 A1
(43) Pub. Date: Mar. 5, 2026

(54) ROLLING BEARING ASSEMBLY AND ELECTRICALLY OPERABLE DRIVE TRAIN OF A MOTOR VEHICLE

(71) Applicant: Schaeffler Technologies AG & Co. KG, Herzogenaurach (DE)

(72) Inventors: Franz Voelkel, Nürnberg (DE); Thomas Stahl, Poppenhausen (DE); Michael Neumann, Schweinfurt (DE)

(73) Assignee: Schaeffler Technologies AG & Co. KG, Herzogenaurach (DE)

(21) Appl. No.: 19/104,375

(22) PCT Filed: Jul. 3, 2023
(86) PCT No.: PCT/DE2023/100503

§ 371 Date: Feb. 18, 2025

(30) Foreign Application Priority Data
Aug. 18, 2022 (DE) 10 2022 120 867.2

(51) Int. Cl. H02K 5/173; B60K 1/00; B60K 6/26; F16C 19/36

(52) U.S. Cl. CPC H02K 5/173; F16C 19/36; B60K 1/00; B60K 6/26; B60Y 2200/91; B60Y 2200/92; B60Y 2400/60; F16C 2380/26

(57) ABSTRACT

A rolling bearing assembly for an electrically operable drive train includes axially spaced first and second angular contact roller bearings, a shaft, rotatably mounted by the bearings, and first and second connecting structures. The first bearing has a first inner race with an inner race track, a first outer race with an outer race track, and rolling bodies arranged to roll on the race tracks at a first contact angle. The second bearing has a second inner race with an inner race track, a second outer race with an outer race track, and rolling bodies arranged to roll on the race tracks at a second contact angle. The first and second inner races are axially and rotationally fixed to the shaft, the first outer race is axially fixed relative to the first connecting structure, and the second outer race is axially displaceable relative to the second connecting structure.

### CROSS-REFERENCE TO RELATED APPLICATIONS

This application is the United States National Phase of PCT Appln. No. PCT/DE2023/100503 filed Jul. 3, 2023, which claims priority to German Application No. DE102022120867.2 filed Aug. 18, 2022, the entire disclosures of which are incorporated by reference herein.

### TECHNICAL FIELD

The present disclosure relates to a rolling bearing assembly for an electrically operable drive train of a motor vehicle, including a shaft which is rotatably mounted by means of a first angular contact roller bearing and a second angular contact roller bearing. The first angular contact roller bearing includes a first inner race, which is connected to the shaft for conjoint rotation, and a first outer race, between which first cylindrical rolling bodies arranged at a first contact angle are accommodated and roll on an inner race track of the first inner race and an outer race track of the first outer race. The second angular contact roller bearing includes a second inner race, which is connected to the shaft for conjoint rotation, and a second outer race, between which second cylindrical rolling bodies arranged at a second contact angle are accommodated and roll on an inner race track of the second inner race and an outer race track of the second outer race. The first angular contact roller bearing and the second angular contact roller bearing are axially spaced apart from each other. The disclosure also relates to an electrically operable drive train of a motor vehicle.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort which they are accustomed to. Axial flow machines are increasingly being used as drive units in such automotive applications.

An axial flux machine is a dynamo-electric machine in which the magnetic flux between the rotor and stator runs parallel to the rotational axis of the rotor. Often, both the stator and the rotor are designed to be largely disc-shaped. Axial flux machines are particularly advantageous when the axially available installation space is limited in a given application. This is often the case, for example, with the electric drive systems for electric or hybrid vehicles described at the outset.

In addition to the shortened axial installation length, a further advantage of the axial flux machine is its comparatively high torque density. The reason for this is, compared to radial flux machines, the larger air gap area which is available for a given installation space. Furthermore, a lower iron volume is required compared to conventional machines, which has a positive effect on the efficiency of the machine.

Typically, an axial flux machine includes at least one stator having windings for generating the axially aligned magnetic field. At least one rotor is equipped with permanent magnets, for example, the magnetic field of which interacts with the magnetic field of the stator windings in order to generate a drive torque over an air gap.

Noise emissions by the drive are playing an increasingly important role, particularly in the case of hybrid or fully electric drive concepts. High electromagnetic excitation, for example, which can also lead to acoustic vibrations in the structural components of the electric machine or drive train, can occur for system-related reasons during operation of such an electric machine for a hybrid or fully electric drive train. This can then also be audible in the interior of the vehicle, which is regularly perceived as intrusive. This is all the more important because in the electric operation of a corresponding vehicle, such noises are particularly noticeable and have a negative impact on the otherwise acoustically particularly quiet driving experience.

Rolling bearing assemblies are usually used to support the rotors in such electric machines. For example, floating bearings are usually pressed onto the rotor shaft so that they have a tight fit on the inner race of the rolling bearing. The bearing outer race is usually designed to be displaceable during operation to compensate for heat-induced linear expansion of the rotor shaft. To create advantageous running conditions between the ball set and the bearing tracks of the floating bearing as well as to improve the acoustics, the bearing outer race is regularly prestressed. The prestressed bearing can prevent unwanted acoustic abnormalities of the corresponding rolling bearing by creating a freedom of play for the bearing components moving against each other.

In addition to the aforementioned increasing acoustic requirements for rolling bearing assemblies within electric drive trains in motor vehicles, there is also a growing need to reduce mechanical power losses, especially in the bearings of shafts of electric machines or transmissions. The reduced power loss in these electric machines and/or transmissions has a directly proportional (positive) effect on power consumption and ultimately on the achievable range of electrically powered motor vehicles.

At the same time as the requirements for minimizing friction losses are being met, the engine torques in the electric drive trains, which then have to be transmitted by the transmissions, are also increasing steadily due to the increased power density achieved. This also increases the loads to be transmitted by the rolling bearings in such electric drive trains.

Standard rolling bearings in a fixed/floating bearing assembly are usually used for such electric machines and/or transmissions. These bearings are usually deep groove ball bearings or 3- or 4-point bearings on the fixed bearing side. Although these bearings are very efficient in terms of friction losses, they also have significantly lower load ratings than roller bearings due to physical reasons (point contact). In order to be able to transmit the required loads, these rolling bearings need to be larger. This means that the electric machines and/or transmissions become larger and heavier and the friction torque also increases significantly again.

In contrast, rolling bearings with higher load ratings can also be used. These are usually tapered roller bearings in an upright assembly. Due to the line contact, these bearings can carry significantly higher loads and can be made smaller and lighter. This has a positive impact on the engine weight and/or the transmission weight and the required installation space. However, upright tapered roller bearings are used in pairs with a relatively high preload. This means that the power losses (due to the higher friction) are higher than with the fixed/floating bearing assembly.

Two embodiments of angular contact roller bearings are known from the publications DE 10 2016 214 353 A1 and DE 10 2016 214 355 A1, which substantially consist of an inner bearing ring with an inner track arranged on its outer lateral surface at an angle to the bearing rotation axis and a rim delimiting this track at its smallest diameter, an outer bearing ring with an outer track, which is also arranged on the inner lateral surface of said bearing ring and at an angle to the bearing rotation axis, and a rim limiting this track at its largest diameter and a plurality of cylindrical rolling bodies arranged between the bearing rings and unrolling on their tracks, which are held at equal distances from one another in the circumferential direction by a bearing cage. The outer lateral surface of the inner bearing ring and the inner lateral surface of the outer bearing ring are designed to be coaxially cylindrical outside the tracks according to DE 10 2016 214 353 A1 or are designed to be obliquely opposed to the bearing rotation axis according to DE 10 2016 214 355 A1, and the tracks of both bearing rings are conically machined respectively into these lateral surfaces, such that the resulting rims, which limit the tracks on one side, are thus formed integrally with the bearing rings.

### SUMMARY

The present disclosure provides a rolling bearing assembly for an electrically operable drive train of a motor vehicle, which allows low friction, a high load rating and acoustically unobtrusive operation. The disclosure also provides an electrically operable drive train of a motor vehicle which has particularly low friction losses and a compact design.

A rolling bearing assembly for an electrically operable drive train of a motor vehicle includes a shaft which is rotatably mounted by means of a first angular contact roller bearing and a second angular contact roller bearing. The first angular contact roller bearing includes a first inner race, which is connected to the shaft for conjoint rotation, and a first outer race, between which first cylindrical rolling bodies arranged at a first contact angle are accommodated and roll on an inner race track of the first inner race and an outer race track of the first outer race. The second angular contact roller bearing includes a second inner race, which is connected to the shaft for conjoint rotation, and a second outer race, between which second cylindrical rolling bodies arranged at a second contact angle are accommodated and roll on an inner race track of the second inner race and an outer race track of the second outer race.

The first angular contact roller bearing and the second angular contact roller bearing are axially spaced apart from each other, and the first inner race of the first angular contact roller bearing and the second inner race of the second angular contact roller bearing are arranged in an axially fixed manner to the shaft. The first outer race of the first angular contact roller bearing is fixed axially relative to a first connecting structure of the rolling bearing assembly, and the second outer race is axially displaceable relative to a second connecting structure. The first inner race has a first inner race rim, the first outer race has a first outer race rim, the second inner race has a second inner race rim and the second outer race has a second outer race rim. The first angular contact roller bearing and the second angular contact roller bearing are substantially not axially prestressed.

This provides the advantage that the rolling bearing assembly has a high load-bearing capacity and service life compared to ball bearing solutions and low friction compared to tapered roller bearing solutions. The angular contact roller bearings are operated without or with only a slight preload. This means that a significantly lower preload force acts on the bearings and the frictional torque is significantly reduced. At the same time, these angular contact roller bearings can still transmit high loads due to the line contact.

The additional inner race rims on the inner races of the angular contact roller bearings ensure that the internal axial play of the angular contact roller bearings is limited and a significant loss of service life of the angular contact roller bearings is thereby prevented. However, the advantages of this bearing, such as load-bearing capacity and friction, are retained.

One possible field of application for the rolling bearing assembly according to the disclosure is in electrically operated drive trains of motor vehicles, for example in electric machines or in dedicated hybrid transmissions, because the installation situation in the respective housings allows a floating or slightly prestressed assembly of the upright angular contact roller bearings without exerting additional constraining forces on the bearing.

The rolling bearing assembly according to the disclosure includes two angular contact roller bearings axially spaced apart from each other. In order to support a shaft in a rotationally movable manner relative to the connecting structures, each of the angular contact roller bearings has an inner race, an outer race and cylindrical rolling bodies arranged in a rolling manner between these races. Between these three main components—inner race, outer race and the rolling bodies—it is usually mainly rolling friction that occurs within the angular contact roller bearing. Since the cylindrical rolling bodies in the inner and outer race can, for example, roll on hardened steel surfaces with optimized lubrication, the rolling friction of such bearings is relatively low.

The inner race can in particular connect the shaft accommodating the angular contact roller bearings to the angular contact roller bearings or the cylindrical rolling bodies. In particular, the shaft can be connected to the side of the lateral surface of the inner ring facing the shaft, and the rolling bodies of the angular contact roller bearing roll on the inner race track opposite this lateral surface. The inner race can be made of a metallic and/or ceramic material. In principle, it is conceivable to design the inner race in one piece or in multiple pieces, in particular in two pieces.

The inner race may have an inner race recess. In particular, a cover washer, sealing washer and/or seal can be arranged in an inner race recess, in particular in a force-fitting and/or form-fitting manner. The inner race recess may be formed as a circumferential groove in the inner race.

The outer race can, in particular, connect the connecting structure with the angular contact roller bearing or the rolling bodies. In particular, the connecting structure can be connected to the side of the lateral surface of the inner ring facing the bearing, and the cylindrical rolling bodies of the angular contact roller bearing roll on the outer race track opposite this lateral surface. The outer race can be made of a metallic and/or ceramic material. In principle, it is conceivable to design the outer race in one piece or in multiple pieces, in particular in two pieces.

The outer race can have an outer race recess. In particular, a cover washer, sealing washer and/or seal can be arranged in an outer race groove, in particular in a force-fitting and/or form-fitting manner. The outer race recess may be formed as a circumferential groove in the outer race.

The rolling bodies have the shape of a roller. They roll on the tracks of the angular contact roller bearing and have the task of transmitting the force acting on the angular contact roller bearing from the outer race to the inner race and vice versa.

Roller-like rolling bodies can be selected, for example, from the group of symmetrical spherical rollers, asymmetrical spherical rollers, cylindrical rollers, needle rollers and/or tapered rollers.

The rolling bodies can roll within the rolling bearing, in particular on the inner race track of the inner race. For this purpose, the surface of the inner race track can be designed to be abrasion-resistant, for example by means of a corresponding surface treatment method and/or by applying a corresponding additional layer of material. The inner race track can be designed to be planar or profiled. A profiled design of the inner race track can be used, for example, to guide the rolling bodies on the inner race track. On the other hand, a planar formation of the inner race track can, for example, allow a certain axial displaceability of the rolling bodies on the inner race track.

The rolling bodies can roll within the rolling bearing, in particular on the outer race track of the outer race. For this purpose, the surface of the outer race track can be designed to be correspondingly abrasion-resistant, for example by means of a corresponding surface treatment method and/or by applying a corresponding additional layer of material.

The outer race track can be designed to be planar or profiled. A profiled design of the outer race track can be used, for example, to guide the rolling bodies on the outer race track. On the other hand, a planar formation of the outer race track can, for example, allow a certain axial displaceability of the rolling bodies on the outer race track.

Rolling bodies can be guided and spaced apart in a cage or by rolling body spacers. In principle, it is also conceivable to design a rolling bearing without a cage, which is also referred to as a full-complement rolling bearing. In full-complement rolling bearings, adjacent rolling bodies can contact one another.

A rolling bearing can have a cage, and the cage guides the rolling bodies. The cage is designed in such a way that the rolling body balls and/or the rolling body rollers are spaced apart from one another so that, for example, the friction and heat development of the rolling bodies is kept low. Furthermore, the cage keeps the rolling body balls and/or rolling body rollers at a fixed distance from one another during rolling, as a result of which an even load distribution can be achieved. The cage can be made in one piece or in multiple pieces.

A rolling bearing can have at least one seal in order to prevent the escape of lubricant from the rolling bearing or the ingress of dirt or moisture into the rolling bearing. For this purpose, the seals used can be provided with one or more seal lips, which can bear against a component of the rolling bearing. These are designed in such a way that, on the one hand, they seal the bearing as long as possible over its entire service life, and on the other hand, the level of friction caused by the contiguous seal is not too high.

According to an example embodiment, it can be provided that a spacer sleeve (intermediate ring/spacer) is arranged axially between the first inner race and the second inner race on the shaft or a raised shaft shoulder (raised shaft section), on which the first inner race and the second inner race rest. The advantage of this design is that the inner races are arranged at a fixed distance from each other. This can be done by a fixing screw fastened in the shaft, which presses the inner races from the outside against the spacer sleeve/intermediate ring or a raised shaft shoulder, which serves as an axially supporting element.

According to a further development, it can also be provided that the first outer race is arranged with play in the radial direction relative to the first connecting structure and/or the second outer race is arranged with play in the radial direction relative to the second connecting structure. This makes it possible for the material of the connecting structure to have a higher thermal expansion than the material of the outer races.

The connecting structure, for example, can be an engine or transmission housing. It may also be advantageous to form the first connecting structure and the second connecting structure in one piece, in particular monolithically.

Furthermore, according to an example embodiment, it can be provided that the first outer race rests axially on a first securing element. The advantageous effect of this design is based on the fact that a very precise axial guidance of the transmission components such as gears, etc., can be ensured during operation.

According to a further embodiment, it can be provided that the first securing element is fixed axially relative to the first connecting structure. In this case, the first securing element can be designed, for example, as a securing ring or the like, which is inserted into the first connecting structure. In principle, it would also be conceivable for the first securing element to be formed integrally, in particular monolithically, with the first connecting structure.

Furthermore, the disclosure can also be further developed in such a way that the second outer race is positioned with axial play relative to a second securing element. The advantage of this design is that a slightly axially floating operation of the rolling bearings would be conceivable. Eliminating the axial load means a lower total load on the rolling bearings, which can be associated with lower friction losses.

In an example embodiment, the second securing element is fixed axially relative to the second connecting structure. In this case, the second securing element can also be designed, for example, as a securing ring or the like, which is inserted into the second connecting structure. In principle, it would also be conceivable here for the second securing element to be formed integrally, in particular monolithically, with the second connecting structure.

The first cylindrical rolling bodies and/or the second cylindrical rolling bodies may be designed as cylindrical rollers or as tapered rollers. The advantage that can be achieved in this way is that the tapered rollers operate with almost no slippage due to the kinematically clean rolling and the cylindrical rollers are easier to manufacture.

Furthermore, it would be possible to form the first inner race rim and/or the second inner race rim in one piece, in particular monolithically, with the first inner race or the second inner race. Alternatively, it is of course also conceivable that the first inner race rim and/or the second inner race rim are each designed as a separate component and are connected to the first inner race or the second inner race.

Analogous to the inner race, it is also possible to form the first outer race rim and/or the second outer race rim in one piece, in particular monolithically, with the first outer race or the second outer race. Alternatively, it is of course also conceivable here that the first outer race rim and/or the second outer race rim are each designed as a separate component and are connected to the first outer race or the second outer race.

According to a further embodiment, it can be provided that the first angular contact roller bearing and the second angular contact roller bearing are arranged in an O-configuration. In principle, it would also be possible to arrange the first angular contact roller bearing and the second angular contact roller bearing in an X-configuration.

The present disclosure also provides an electrically operable drive train of a motor vehicle, including an electric machine and a transmission assembly coupled to the electric machine. The electric machine has a stator and a rotor arranged to be rotatable relative to the stator, and the rotor and/or a shaft of the transmission assembly is/are mounted by means of a rolling bearing assembly described above.

An electrically operable drive train can include an electric machine and a transmission assembly coupled to the electric machine. The transmission assembly and the electric machine can also form a structural unit. This can be formed, for example, by means of a drive train housing, in which the transmission assembly and the electric machine are accommodated together.

The electric machine may have a motor housing and/or the transmission assembly may have a transmission housing, and the structural unit can then be implemented by fixing the transmission assembly in relation to the electric machine.

The transmission housing is a housing for accommodating a transmission. It has the task of guiding existing shafts via the bearings and giving the wheels (cam discs, where applicable) the degrees of freedom they require under all loads without impeding their rotational and possible path movement, as well as absorbing bearing forces and supporting torques. A transmission housing can be designed as single-shell or multi-shell, i.e., undivided or divided. In particular, the transmission housing should be able to dampen noise and vibrations as well as safely absorb hydraulic fluid. The transmission housing may be formed from a metallic material, e.g., from aluminum, gray cast iron or cast steel, in particular by means of a primary shaping process such as casting or die-casting.

The motor housing encloses the electric machine. A motor housing can also accommodate the control and power electronics. The motor housing can furthermore be part of a cooling system for the electric machine, and can be designed such that hydraulic fluid can be supplied to the electric machine via the motor housing and/or the heat can be dissipated to the outside via the housing surfaces. In addition, the motor housing protects the electric machine and any electronics that may be present from external influences. A motor housing can be formed in particular from a metallic material. The motor housing can be formed from a metallic cast material, such as die-cast aluminum, die-cast magnesium, gray cast iron, or cast steel. The motor housing can be designed in a plurality of parts.

The electric machine is used to convert electrical energy into mechanical energy and/or vice versa, and generally comprises a stationary part referred to as a stator, stand, or armature, and a part referred to as a rotor or runner, and arranged movably, in particular rotatably, relative to the stationary part.

In particular, the electric machine is dimensioned such that vehicle speeds of more than 50 km/h, e.g., more than 80 km/h, and in particular more than 100 km/h can be achieved. The electric motor may have an output of more than 30 kW, e.g., more than 50 kW, and in particular more than 70 kW. Furthermore, the electric machine may provide speeds greater than 5000 rpm, e.g., greater than 10,000 rpm, and in particular greater than 12,500 rpm.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

### BRIEF DESCRIPTION OF THE DRAWINGS

The present disclosure is explained in more detail below with reference to figures without limiting the general concept of the disclosure.

In the drawings:

FIG. 1 shows an axial sectional view of a first rolling bearing assembly for an electrically operable drive train of a motor vehicle,

FIG. 2 shows an axial sectional view of a second rolling bearing assembly for an electrically operable drive train of a motor vehicle, and

FIG. 3 shows a fully electric and a hybrid motor vehicle in a schematic block diagram.

### DETAILED DESCRIPTION

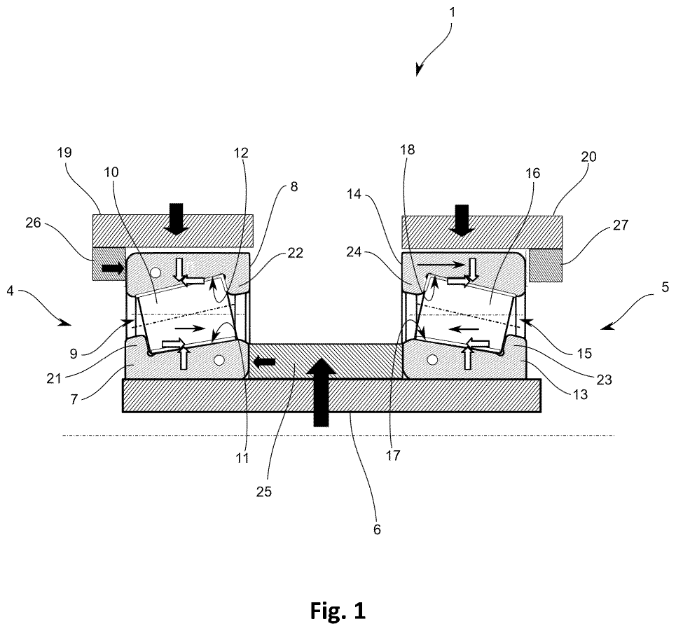

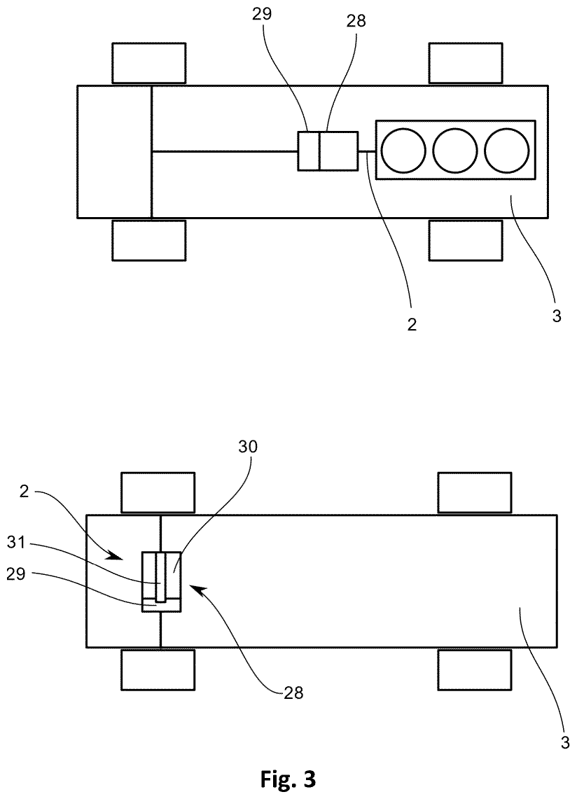

FIG. 1 shows a rolling bearing assembly 1 for an electrically operable drive train 2 of a motor vehicle 3 (ref. FIG. 3), including a shaft 6 which is rotatably mounted by means of a first angular contact roller bearing 4 and a second angular contact roller bearing 5.

The first angular contact roller bearing 4 includes a first inner race 7, which is connected to the shaft 6 for conjoint rotation, and a first outer race 8, between which first cylindrical rolling bodies 10 arranged at a first contact angle 9 are accommodated and roll on an inner race track 11 of the first inner race 7 and an outer race track 12 of the first outer race 8.

The second angular contact roller bearing 5 includes, analogously thereto, a second inner race 13, which is connected to the shaft 6 for conjoint rotation, and a second outer race 14, between which second cylindrical rolling bodies 16 arranged at a second contact angle 15 are accommodated and roll on an inner race track 17 of the second inner race 13 and an outer race track 18 of the second outer race 14.

The first cylindrical rolling bodies 10 and the second cylindrical rolling bodies 16 are designed as cylindrical rollers or as tapered rollers. As can be clearly seen from FIG. 1, the two angular contact roller bearings 4, 5 are substantially identical in design, but are rotated by 180° relative to each other and arranged to be axially spaced apart from each other on the shaft 6.

The first inner race 7 of the first angular contact roller bearing 4 and the second inner race 13 of the second angular contact roller bearing 5 are arranged in an axially fixed manner to the shaft 6. The first outer race 8 of the first angular contact roller bearing 4 is fixed axially relative to a first connecting structure 19 of the rolling bearing assembly 1. The fixation of these races is also symbolized in FIG. 1 by the unmarked circles in the respective races. It can be seen that the first angular contact roller bearing 4 is designed as a fixed bearing and the second angular contact roller bearing 5 is designed as a floating bearing. The second outer race 14 is axially displaceable relative to a second connecting structure 20.

The first outer race 8 rests axially on a first securing element 26 and is thus axially fixed on one side. The first securing element 26 is fixed axially relative to the first connecting structure 19. The inner races 7, 14 can be fixed to be axially secured on the shaft 6, for example by means of a press fit. A spacer sleeve 25 is arranged axially between the first inner race 7 and the second inner race 13 on the shaft 6, on which the first inner race 7 and the second inner race 13 rest.

In the embodiment shown, the spacer sleeve 25 is an intermediate ring or spacer on the shaft 6. It would of course also be possible to form the spacer sleeve 25 in one piece with the shaft 6, so that a radially raised shaft shoulder is formed, on which the inner races 7, 13 rest. The inner races 7, 13 are arranged at a fixed distance from each other. This can be done, for example, by a fixing screw fastened to the shaft 6, which presses the inner races 7, 13 from the outside against the spacer sleeve 25 or a raised shaft shoulder, which serves as an axially supporting element.

The first angular contact roller bearing 4 and the second angular contact roller bearing 5 are substantially not axially prestressed.

Furthermore, it can be clearly seen from FIG. 1 that the first inner race 7 has a first inner race rim 21, the first outer race 8 has a first outer race rim 22, the second inner race 13 has a second inner race rim 23 and the second outer race 14 has a second outer race rim 24. The first cylindrical rolling bodies 10 do not run on the first inner race rim 21, which is due to the geometry of the first angular contact roller bearing 4.

Depending on the operating temperatures and the initial preload applied to the securing element 26, the cylindrical rolling body 10 designed as a tapered roller presses itself against the outer race rim 22 due to the cone effect, which is indicated by the black solid arrow. In certain (rather low-load) cases, contact with the inner race rim 21 may occur. This does not significantly impair the efficiency of the angular contact roller bearings 4, 5, but on the other hand can have a positive effect on preventing roller sagging.

The first outer race 8 is arranged with play in the radial direction relative to the first connecting structure 19 and the second outer race 14 is arranged with play in the radial direction relative to the second connecting structure 20, which can be easily understood from the illustrated ring-shaped gaps between the outer races 8, 14 and the connecting structures 19, 20.

The second outer race 14 is positioned with axial play relative to a second securing element 27, wherein the second securing element 27 itself is fixed axially relative to the second connecting structure 20.

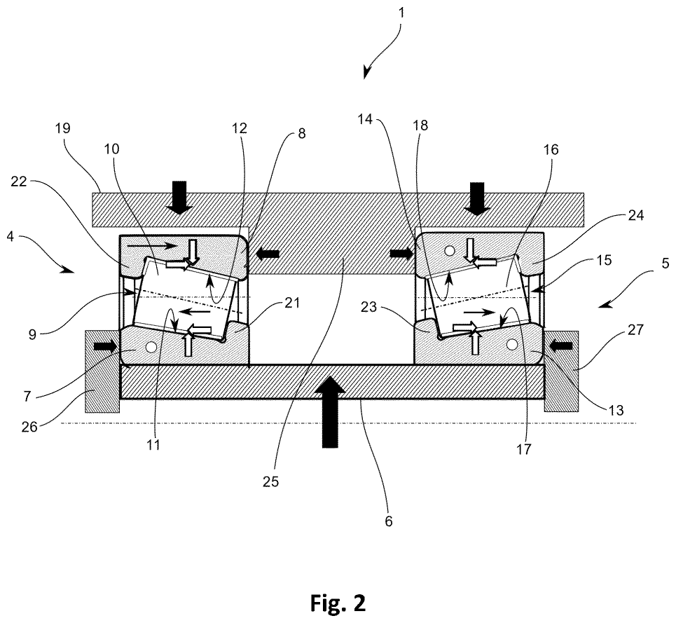

In the exemplary embodiment of FIG. 1, the first angular contact roller bearing 4 and the second angular contact roller bearing 5 are arranged in an O-configuration. In the exemplary embodiment of FIG. 2, the first angular contact roller bearing 4 and the second angular contact roller bearing 5 are shown in an X-configuration. In this embodiment of FIG. 2, the spacer sleeve 25 is formed monolithically with the connecting structure 19, and the outer races 8, 14 are axially supported on the spacer sleeve 25. The inner races 7, 13 rest axially on the securing elements 26 and 27 respectively.

FIG. 3 shows two embodiments of an electrically operable drive train 2 of a motor vehicle 3, each including an electric machine 28 and a transmission assembly 29 coupled to the electric machine 28. The electric machine 28 has a stator 30 and a rotor 31 arranged to be rotatable relative to the stator 30. Here, the rotor 31 and/or a shaft of the transmission assembly 29 is mounted by means of a rolling bearing assembly 1 as shown in FIG. 1 or FIG. 2.

The terms “radial,” “axial,” “tangential,” and “circumferential direction” used in this application always refer to the rotational axis R of the shaft 6. The terms “left,” “right,” “above,” “below,” “over,” and “under” are used here only to clarify which areas of the illustrations are currently being described in the text. The later embodiment may also be arranged differently. The disclosure is further not limited to the embodiments shown in the figures. The above description is therefore not to be regarded as limiting, but rather as illustrative. The following claims are to be understood as meaning that a stated feature is present in at least one embodiment. This does not exclude the presence of further features. Where the claims and the above description define ‘first’ and ‘second’ features, this designation serves to distinguish between two features of the same type without defining an order of precedence.

### Reference Numerals

1 Rolling bearing assembly
2 Drive train
3 Motor vehicle
4 Angular contact roller bearing
5 Angular contact roller bearing
6 Shaft
7 Inner race
8 Outer race
9 Contact angle
10 Cylindrical rolling bodies
11 Inner race track
12 Outer race track
13 Inner race
14 Outer race
15 Contact angle
16 Cylindrical rolling bodies
17 Inner race track
18 Outer race track
19 Connecting structure
20 Connecting structure
21 Inner race rim
22 Outer race rim
23 Inner race rim
24 Outer race rim
25 Spacer sleeve
26 Securing element
27 Securing element
28 Electric machine
29 Transmission assembly
30 Stator
31 Rotor

1. A rolling bearing assembly for an electrically operable drive train of a motor vehicle, comprising a shaft which is rotatably mounted by means of a first angular contact roller bearing and a second angular contact roller bearing,
the first angular contact roller bearing comprising a first inner race, which is connected to the shaft for conjoint rotation, and a first outer race, between which first cylindrical rolling bodies arranged at a first contact angle are accommodated and roll on an inner race track of the first inner race and an outer race track of the first outer race, and
the second angular contact roller bearing comprising a second inner race, which is connected to the shaft for conjoint rotation, and a second outer race, between which second cylindrical rolling bodies arranged at a second contact angle are accommodated and roll on an inner race track of the second inner race and an outer race track of the second outer race,
the first angular contact roller bearing and the second angular contact roller bearing being axially spaced apart from each other, wherein:
the first inner race of the first angular contact roller bearing and the second inner race of the second angular contact roller bearing are arranged in an axially fixed manner to the shaft,
the first outer race of the first angular contact roller bearing is fixed axially relative to a first connecting structure of the rolling bearing assembly, and
the second outer race is axially displaceable relative to a second connecting structure, wherein
the first inner race comprises a first inner race rim, the first outer race comprises a first outer race rim, the second inner race comprises a second inner race rim and the second outer race comprises a second outer race rim and
the first angular contact roller bearing and the second angular contact roller bearing are substantially not axially prestressed.

2. The rolling bearing assembly according to claim 1, wherein:
a spacer sleeve is arranged axially between the first inner race and the second inner race on the shaft, on which the first inner race and the second inner race rest.

3. The rolling bearing assembly according to claim 1, wherein:
the first outer race is arranged with play in a radial direction relative to the first connecting structure and/or the second outer race is arranged with play in a radial direction relative to the second connecting structure.

4. The rolling bearing assembly according to claim 1, wherein:
the first outer race rests axially on a first securing element.

5. The rolling bearing assembly according to claim 4, wherein:
the first securing element is fixed axially relative to the first connecting structure.

6. The rolling bearing assembly according to claim 1, wherein:
the second outer race is positioned with axial play relative to a second securing element.

7. The rolling bearing assembly according to claim 6, wherein:
the second securing element is fixed axially relative to the second connecting structure.

8. The rolling bearing assembly according to claim 1, wherein:
the first cylindrical rolling bodies and/or the second cylindrical rolling bodies are designed as cylindrical rollers or as tapered rollers.

9. The rolling bearing assembly according to claim 1, wherein:
the first angular contact roller bearing and the second angular contact roller bearing are arranged in an O-configuration.

10. An electrically operable drive train of a motor vehicle, comprising an electric machine and a transmission assembly coupled to the electric machine, the electric machine comprising a stator and a rotor arranged to be rotatable relative to the stator, the rotor and/or a shaft of the transmission assembly being mounted by means of a rolling bearing assembly according to claim 1.

11. A rolling bearing assembly for an electrically operable drive train, comprising:
a first angular contact roller bearing, comprising:
a first inner race comprising a first inner race track;
a first outer race comprising a first outer race track; and
a first plurality of rolling bodies arranged to roll on the first inner race track and the first outer race track at a first contact angle;
a second angular contact roller bearing, axially spaced from the first angular contact roller bearing, comprising:
a second inner race comprising a second inner race track;
a second outer race comprising a second outer race track; and
a second plurality of rolling bodies arranged to roll on the second inner race track and the second outer race track at a second contact angle;
a shaft, rotatably mounted by the first angular contact roller bearing and the second angular contact roller bearing;
a first connecting structure; and
a second connecting structure, wherein:
the first inner race is axially and rotationally fixed to the shaft for cojoint rotation;
the first outer race is axially fixed relative to the first connecting structure;
the second inner race is axially and rotationally fixed to the shaft for cojoint rotation; and
the second outer race is axially displaceable relative to the second connecting structure.

12. The rolling bearing assembly of claim 11, further comprising a spacer sleeve arranged axially between the first inner race and the second inner race.

13. The rolling bearing assembly of claim 11, wherein:
there is a radial play between the first outer race and the first connecting structure; or
there is a radial play between the second outer race and the second connecting structure.

14. The rolling bearing assembly of claim 11, further comprising a first securing element, wherein:
the first securing element is axially fixed relative to the first connecting structure; and
the first outer race rests axially on the first securing element.

15. The rolling bearing assembly of claim 11, further comprising a second securing element, wherein:
the second securing element is axially fixed relative to the second connecting structure; and
the second outer race is positioned with an axial play relative to the second securing element.

16. The rolling bearing assembly of claim 11, wherein:
the first plurality of rolling bodies are cylindrical rollers or tapered rollers; and
the second plurality of rolling bodies are cylindrical rollers or tapered rollers.

17. The rolling bearing assembly of claim 11, wherein:
the first angular contact roller bearing and the second angular contact roller bearing are arranged in an O-configuration; or
the first angular contact roller bearing and the second angular contact roller bearing are arranged in an X-configuration.
